(19) United States
(12) Patent Application Publication
(10) Pub. No.: US 2006/0000676 A1
(43) Pub. Date: Jan. 5, 2006

(54) Outrigger stabilizer and ladder combination

(76) Inventor: Paul V. Ramirez, Warren, MI (US)

Correspondence Address: JOHN R. BENEFIEL, 280 DAINES ST., #100 B, BIRMINGHAM, MI, 48009, US

(21) Appl. No.: 11/087,060

(22) Filed: Mar. 22, 2005

Related U.S. Application Data
(63) Continuation-in-part of application No. 10/819,476, filed on Apr. 7, 2004, now abandoned.
(60) Provisional application No. 60/461,499, filed on Apr. 9, 2003.

(51) Int. Cl. E06C 1/00

(52) U.S. Cl. 182/172

(57) ABSTRACT

An outrigger stabilizer combined with a ladder includes a telescoped outer tube and inner elongated member with a one way brake freely allowing telescoping movement of the inner member out of the outer tube to automatically adjust to engage the ground but instantly locking together when any collapsing movement is attempted to brace the ladder in any adjusted position.

### CROSS REFERENCE TO RELATED APPLICATIONS

This application is a continuation-in-part of U.S. Ser. No. 10/819,476, filed on Apr. 4, 2004 and also claims the benefit of U.S. provisional Ser. No. 60/461,499, filed Apr. 9, 2003 since it was claimed in the parent application, U.S. Ser. No. 10/819,476.

### BACKGROUND OF THE INVENTION

This invention concerns ladder stabilizers which act to brace a ladder to prevent falls when a ladder leaned against a wall or other structure slides to either side step ladder also can tip over to either side as when a user shifts his or her weight or leans too far to the side.

This hazard very commonly causes falls, particularly where a ladder rests on an uneven surface. Numerous ladder stabilizers have been devised to avoid this problem, including mounting telescoping outriggers to each side of a ladder, sloping downwardly from a point of attachment to each ladder stile and having an end engaged with the ground or other supporting surface.

The problem with these prior outrigger stabilizers is the need to manually carefully adjust the length of each outrigger to securely engage the surface of each situation. This is a time consuming chore and thus is often not done or only done haphazardly.

Another problem is that the adjusted length is sometimes not well secured or a thumbscrew becomes loose, allowing free telescoping of the outrigger components to occur and this defeats the purpose of the stabilizer. Also, the ladder may shift as the user moves on the ladder which could shift the stabilizer lower end where it may not reach the ground.

It is important that such a stabilizer be simple, convenient, failsafe, and low in cost to manufacture.

It is the object of the present invention to provide an outrigger type ladder stabilizer which does not require that manual adjustments be made and is very securely held in each adjusted condition.

### SUMMARY OF THE INVENTION

The above object and others which will become apparent upon a reading of the following specification and claims are achieved by an outrigger stabilizer comprised of a pair of telescoped tubes with an inner tube slidable in an outer tube connected at its upper end to one side of the ladder, extending down laterally therefrom. The two tubes are interconnected with a one way acting brake which allows the inner tube to freely telescope out from the outer tube, but instantly locks to the outer tube when any movement to telescope the inner tube back into the outer tube is attempted. This provides an automatic length adjustment and a secure locking of the stabilizer in each adjusted length. The one way brake comprises an arrangement wherein the upper end of the outer lower tube mounts an inclined annular disc having a hole through which the inner tube is loosely fit. A metal strip fixed to the upper end of the outer tube is formed with an inclined reaction tab which engages the bottom of one side of the annular disc so that it assumes a downwardly inclined orientation as the opposite side of the disc tilts down under its own weight.

The inclined annular disc acts as a one way acting brake while it allows the outer tube to telescope out from the outer tube but instantly wedges to the inner tube and to lock the two tubes together when forces are exerted on the stabilizer tending to telescope the two tubes back together. The friction between the side of the inner tube and one edge of the disc hole causes a wedging action to instantly occur. The length adjustment occurs automatically by gravity when the ladder is placed against a vertical support and the lower tube descends until the ground or other surface is encountered by its bottom end. At the same time, the locking action is very secure and will not loosen.

The inner tube may be quickly released to allow telescoping back into the outer tube by lifting up on the tilted down side of the disc.

The strip may also have an upper tab sloping back inwardly which causes the annular disc to tilt in the opposite direction and prevents escape of the inner tube when the stabilizer is inverted. A disc keeper element can also be provided.

Any tipping action is positively resisted by attaching an outrigger stabilizer on each side of the ladder.

An outrigger stabilizer according to the invention can be quickly mounted to each side of the ladder by a cross tube passed through a selected rung hole and each end received in a hole on the upper end of the inner tube, retained therein with an end cap.

The stabilizer may also be secured to a step ladder by an adjustable clamp mounted to the top of each upper tube and gripping a respective step ladder stile.

### DESCRIPTION OF THE DRAWINGS

FIG. 1 is a pictorial view of an extension ladder having a pair of outrigger stabilizers according to the invention installed thereon and deployed on the adjacent ground surfaces.

FIG. 1A is a pictorial exploded view of the outrigger stabilizers shown in FIG. 1, with the extension ladder on which they are installed.

FIG. 2 is an enlarged partially sectional fragmentary view of the upper end of the telescoped tubes included in the stabilizer shown in FIGS. 1 and 1A and a one way brake associated therewith.

FIG. 3 is a pictorial view of the upper end of the telescoped tubes and a second form of the one way brake shown in FIG. 2, shown rotated towards the viewer.

FIG. 4 is a pictorial view of the upper end of the outer tube with phantom lines showing a section to be removed in manufacturing an integral reaction tab included in an alternate embodiment of the one way brake.

FIG. 5 is a pictorial view of a step ladder having an outrigger stabilizer according to another embodiment of the invention installed thereon.

FIG. 6 is an enlarged exploded pictorial view of the upper end of the outrigger stabilizer and adjacent portions of the stepladder shown in phantom lines.

FIG. 7 is a sectional view of portions of another embodiment of the invention.

FIG. 8 is a pictorial view of the upper end of the outer tube shown in FIG. 7.

FIG. 9 is a partially sectional and pictorial view of portions of yet another embodiment of the invention.

FIG. 10 is a sectional view through the lower tube shown in FIG. 9.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

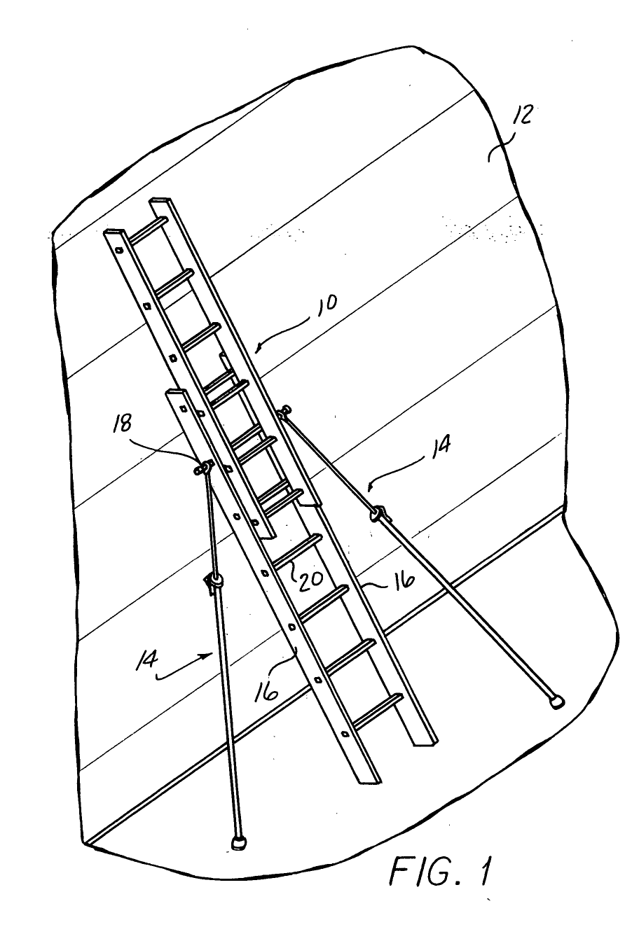

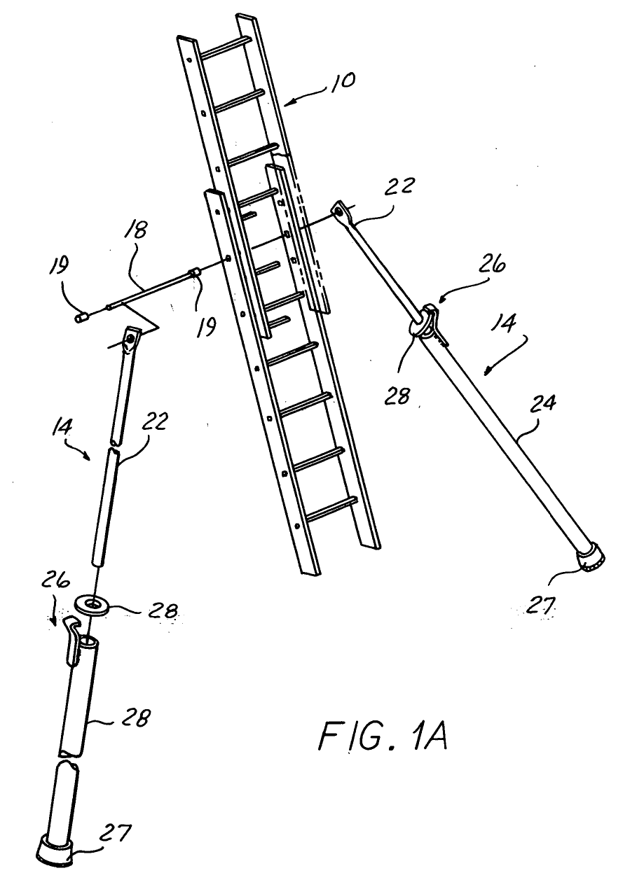

Referring to the drawings, and FIGS. 1-4, an extension ladder 10 is shown leaning against a building wall 12, the ladder 10 resting on the adjacent ground surface. A pair of outrigger stabilizers 14 according to the invention each have an attachment at their upper end to the side of a respective ladder stile 16.

This attachment is preferably accomplished by installing a cross tube 18 through one of the normally hollow rungs 20 of the ladder 10 at an intermediate height thereon.

Each outrigger stabilizer 14 extends at an outward angle and rests on the adjacent ground surface so as to provide a bracing of the ladder 10, resisting any tendency to slide or tip sideways.

Each outrigger stabilizer 14 automatically adjusts in length to have its lower end brought into secure contact with the ground surface regardless of the unevenness of the ground surface adjacent the ladder 10.

This is accomplished by the telescoping out of an inner elongated member comprised of an inner tube 22 slidably received in an outer tube 24 (FIG. 1A) thickness as the outer tube 24 drops down from its own weight. These 22, 24 tubes are constructed of metal, such as of steel or aluminum and have a sufficiently heavy wall to provide a sturdy support, able when extended to resist the force exerted by the ladder 10 and if any tendency to tip sideways occurs.

The inner tube 22 has a flattened tip 25 which has a hole 23 formed therein sized to receive the cross tube 18. A pair of retainer end caps 19 are installed to keep the same on a respective tube end. The lower end of each outer tube 24 has a nonskid tip 27 installed thereon.

A one way acting brake 26 is installed on the upper end of the outer tube 24 which allows the inner tube 22 to freely telescope out of the outer tube 24, as the outer tube 24 drops away under the influence of gravity but instantly engages to rigidly connect together the tubes 24, 26 to resist any telescoping together of these tubes 22, 24 if a pushing force is exerted on the upper tube 22 after the outer tube 24 contacts the supporting surface.

Each one way acting brake 26 comprises an annular disc 28, preferably of steel which is held at an inclined angle on the upper end of the outer tube by an upwardly and outwardly angled reaction tab 30 formed in a metal strip 32 affixed as by welding or by other means to one side of the upper end of the outer tube 24. The reaction tab 30 contacts the bottom surface of the left side of the disc 28 when the stabilizer 14 is upright.

An upwardly and inwardly angled tab 34 may also be formed at the end of the strip 32, contacting the left side of the disc 28 when the stabilizer 14 is inverted to prevent escape of the inner tube 22.

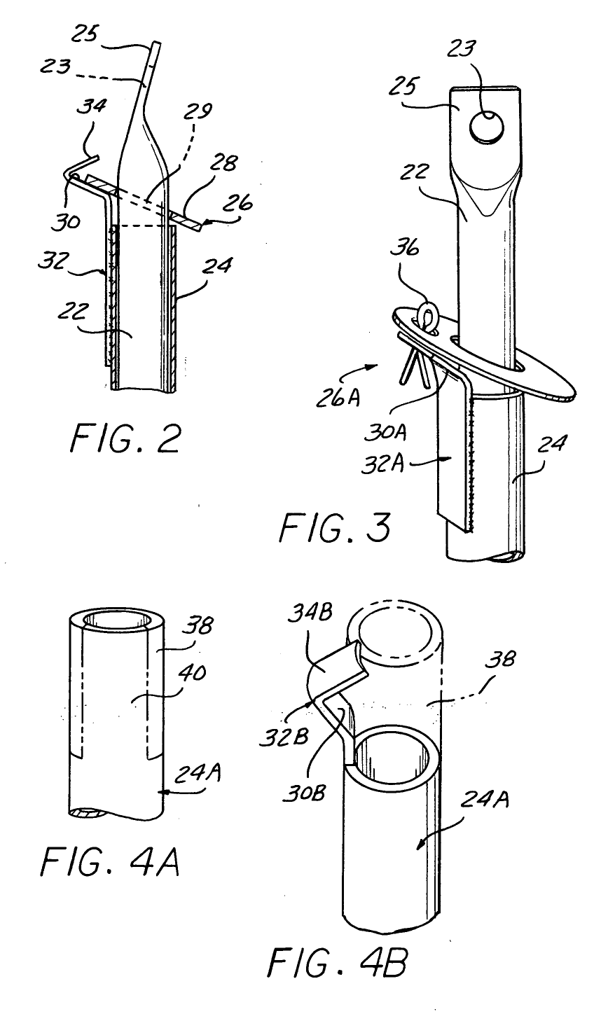

As noted, the hole 29 in the annular disc 28 is sufficiently larger than the inner tube 22 to allow the same to assume the tilted downward orientation shown in FIG. 2.

Since the inner tube 22 is held on the cross tube 18, the outer tube 24 will freely drop down, sliding along the inner tube 22 which is thereby telescoped out of the outer tube 24. The annular disc 28 assumes a downwardly angled orientation, tilting down to the right as viewed in FIG. 2, under the influence of gravity and the left side is held up by engagement with the reaction tab 30. Thus, the friction between the edge of the hole 29 in the annular disc 28 tends to lift and straighten the disc 28, increasing the clearance between the upper tube 22 and the disc 28 when the inner tube 22 is telescoping out of the outer tube 24.

On the other hand, when the inner tube 22 starts to move relatively towards the outer tube 24 to be telescoped thereinto, friction between the inner tube 22 and the edge of the hole in the disc 28 immediately drives the right side of the disc 28 further down to increase the inclination thereof to eliminate the clearance between the hole 29 in the annular disc 28 and create a wedging between inner tube 22 and the disc 28 since the disc 28 is restrained by the reaction tab 30. This positively prevents the inner tube 22 from moving into the outer tube 24.

The reversely angled reaction tab 34 creates the same action if the ladder 10 is angled down as during handling so that the inner tube 22 will be locked and not fall out of the outer tube 24 inadvertently.

FIG. 3 shows another form of the one way acting brake 26A. In this version, the strip 32A is formed only with the outwardly and upwardly angled tab 30A. A cotter pin 36 is installed in holes through the disc perimeter and the tab 36 to retain the disc 28. The fit thereon is loose enough to allow reversing of the inclination of the annular disc 28 to capture the inner tube 22 when inverted.

FIGS. 4A and 4B show an alternate construction in which the upper end of the outer tube 24 has a portion 38 cut away to leave a segment 40. That segment is formed to create an integral strip 32B and tabs 30B and 34B.

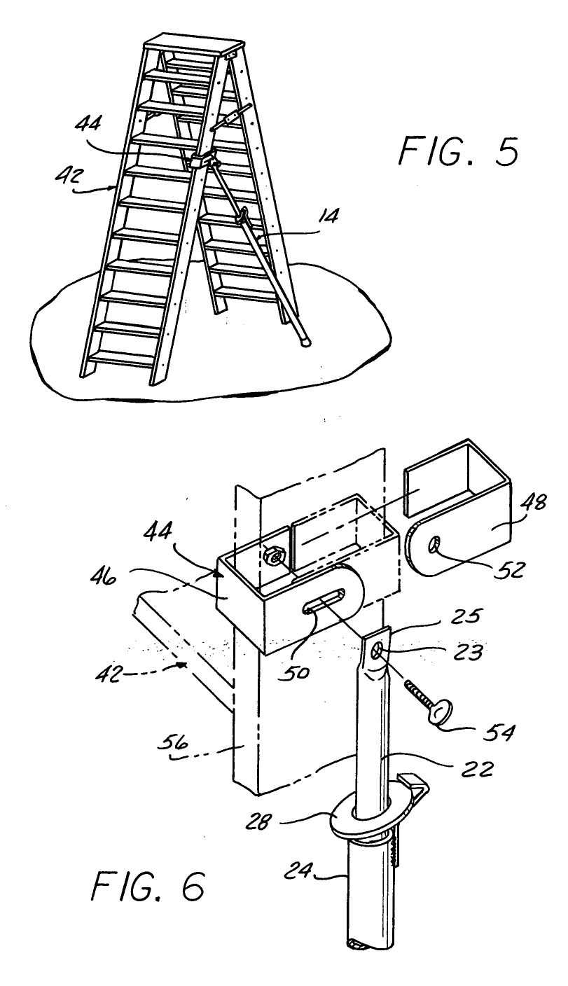

FIGS. 5 and 6 show the mounting of an outrigger stabilizer 14 mounted to a stepladder 42 by a stile clamp 48. The clamp 44 comprises a pair of U-shaped pieces 46, 48 fit together to be slidably adjustable to various sized stiles.

A slot 50 and a hole 52 receive a screw 54 which also passes through a drilled hole in the ladder stile 56, with a nut 58 tightened to secure the same in any adjusted position to fit the same to stiles of various widths.

Thus, a simple but very convenient to use outrigger stabilizer has been provided which is also very reliable in preventing sideways tipping of a ladder to alleviate a major source of ladder accidents.

In one successful design, the tabs 30 and 34 were about three quarters of an inch long, with about a 20° angle there between. The lower side of the inclined annular disc 28 was located to have about one quarter of an inch clearance with the top edge of the outer tube 24 to insure that contact would not occur and wedging engagement with the inner tube 22 was assured. The outer tube 24 was 57.5 inches long and the inner tube 22 was 60 inches in length to insure that an upper end protruded therefrom when the two tubes were collapsed together.

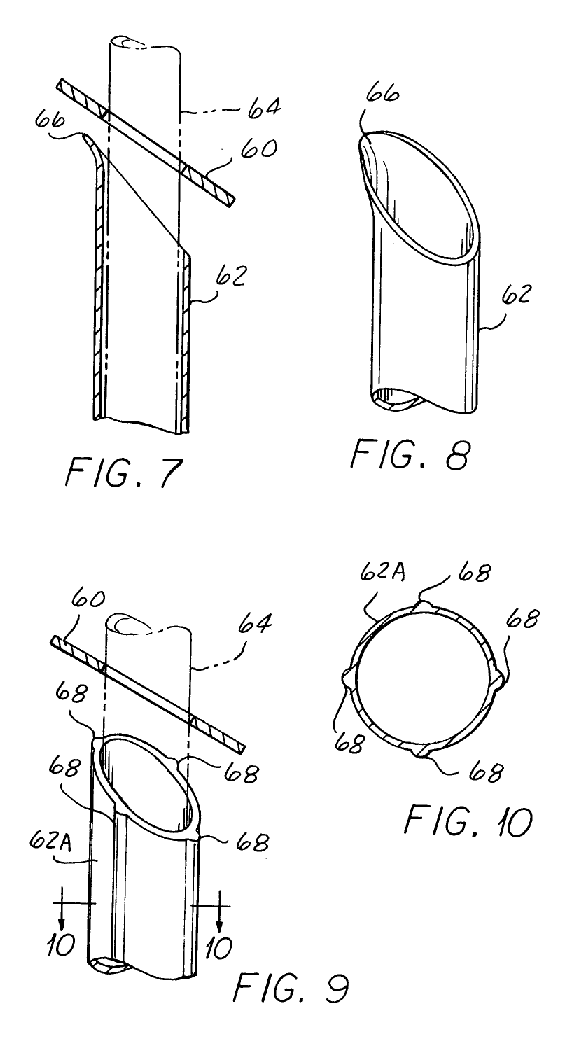

FIGS. 7 and 8 show a simplified form of the invention in which an annular disc 60 is not mounted to either outer tube 62 or inner tube 64. Rather, the annular disc 60 is simply slidably held on the inner tube 64, with the inside diameter of the annular disc 60 being larger than the outside diameter of the inner tube 64 to allow it to incline as shown sufficiently to create a wedging action to the inner tube 64 when restrained on one side by an elevated crest 66 on the outer tube 62.

This crest 66 is created by cutting off the outer tube at an angle as shown. The annular disc 60 thus drivingly engages the lower tube 62 by contact with the crest and is wedged to the inner tube 64 when the inner tube 64 is slid into the outer tube 62. When the inner tube 62 slides out, no engagement of the disc 60 occurs, with either tube. Thus, a one way brake is provided.

The crest 66 is preferably formed over and outwardly to create a larger dimension across the outer tube 62. This prevents the outer tube 62 from entering the inside diameter of the annular disc 60.

FIGS. 9 and 10 shows a variation in which the lower tube 62A is extruded with a series of outside ribs 68 which create a larger dimension across the lower tube 62A.

1. An outrigger stabilizer in combination with a ladder comprising:
an outer tube;
an inner elongated member slidably received in said outer tube;
an attachment adapted to connect one end of said elongated member or outer tube to a ladder stile;
a one way acting brake drivingly engaging said outer tube and acting on said inner member to prevent telescoping movement of said inner member into said outer tube while freely allowing telescoping movement out of said outer tube, whereby the length of said stabilizer can increase automatically by telescoping of said outer tube and inner member apart until engaging a support surface and thereafter preventing telescoping together of said outer tube and inner member.

2. The combination according to claim 1 wherein said one way brake includes an annular disc having a hole receiving said inner member with sufficient clearance to allowing substantial tilting of said disc thereon, and
a reaction feature fixed to said outer tube positively engaging one side of said annular disc to cause the other side of said annular disc to tilt towards the direction of movement of said inner member when telescoping into said outer tube, whereby said disc wedges against said inner member when said inner member attempts to telescope into said outer tube and said positive engagement of said feature positively prevents said telescoping movement of said inner member into said outer member.

3. The combination according to claim 2 wherein said reaction feature comprises a tab affixed to said outer tube.

4. The combination according to claim 3 wherein said tab is mounted above an upper end of said outer tab inclined outwardly and at an angle.

5. The combination according to claim 4 wherein said tab is fixed relative to said outer tube by a metal strip extending from said upper end thereof.

6. The combination according to claim 5 wherein said strip is welded to an outside wall of said outer tube.

7. The combination according to claim 5 wherein said strip is integrally formed from a portion of said outer tube.

8. The combination according to claim 2 wherein said feature is located above an upper end of said outer tube whereby said annular disc other side tilts down under the influence of gravity.

9. The combination according to claim 4 further including a second inclined tab extending up and inwardly from an upper end of said first mentioned tab to engage said other side of said annular disc when said stabilizer is inverted to wedge to said inner tube prevent telescoping movement of said inner member out of said outer tube.

10. The combination according to claim 4 further including a keeper element securing said disc to said tab.

11. The combination according to claim 1 wherein said attachment comprises an elongated element passed through a rung hole in said ladder and having one end received through a hole in a protruding end of said inner member, and a retainer preventing removal therefrom.

12. The combination according to claim 1 wherein said ladder is a stepladder and said attachment is an adjustable clamp engaging a ladder stile and secured to a protruding end of said inner member.

13. The combination according to claim 2 wherein said reaction feature comprises a crest formed by an angled end of said outer tube.

14. The combination according to claim 13 wherein said crest is formed out to prevent said crest from entering the inside diameter of said annular disc.

15. The combination according to claim 14 wherein said outer tube is formed with one or more ribs on the outside diameter.
